(19) United States
(12) Patent Application Publication
(10) Pub. No.: US 2025/0052603 A1
(43) Pub. Date: Feb. 13, 2025

(54) FLOWMETER WITH ADJUSTABLE READING DIRECTIONS

(71) Applicant: Fujian Joyo Technology Co., Ltd, Minhou County (CN)

(72) Inventors: Wang Lin, Minhou County (CN); Yuping Lin, Minhou County (CN)

(21) Appl. No.: 18/232,835

(22) Filed: Aug. 11, 2023

(51) Int. Cl. G01F 15/06; G01F 1/74; G01F 15/02

(52) U.S. Cl. CPC G01F 15/068; G01F 1/74; G01F 15/024

(57) ABSTRACT

A flowmeter with adjustable reading directions is provided, which includes a flowmeter main body, a casing and a digital display device. The casing is arranged at an outer side of the flowmeter main body; the digital display device is electrically connected with the flowmeter main body so as to read the numerical value of the flowmeter main body. The digital display device is rotatably connected on the casing to adjust the display direction of the numerical value in the digital display device. The digital display device is rotatably connected to the casing, so that the digital display device is equivalent to being indirectly arranged on the flowmeter main body, by rotating the digital display device, the digital display device can align with and face to the working personnel, such that it is convenient for the working personnel to read and record the numerical value.

### FIELD OF THE INVENTION

The present invention relates to the technical field of flowmeters, and more particularly to a flowmeter with adjustable reading directions.

### BACKGROUND OF THE INVENTION

A flowmeter generally refers to an instrument for measuring a flow rate and a total amount of fluid in a selected time interval, simply an instrument for measuring the flow of a fluid in a pipe or open channel. The existing flowmeter generally induces the rotation of a turbine through a magnetic induction device, so as to realize the collection of the rotating speed information of the turbine, so as to realize the recording of the pipeline data, the accuracy is high, the aging effect is strong, so that the application is wide, are common metering equipment in various industrial fields.

The digital display panel of the existing flowmeter is usually fixedly connected above the flowmeter, however, in the actual installation process, the installation position of digital display device is often adjusted according to the difference of terrain, these special mounting positions may cause inconvenience to later operators. Specifically, when reading or photographing the flowmeter through the digital display panel is required, the operator needs to carry out reading and recording work according to the installation direction of the flowmeter, if the operator does not perform the recording work from the correct viewing angle, recording errors tend to occur in the course of observation, and the poor posture tends to accelerate the tiredness of the operator, and the efficiency of the recording work is reduced.

### SUMMARY OF THE INVENTION

### (1) Solved Technical Problem

In order to resolve the above problem, the invention relates to a flowmeter which can conveniently read numerical values, which can adjust the reading direction of a digital display device.

### (2) Technical Solution

To achieve the above purpose, the present invention provides the following technical solution:

A flowmeter with adjustable reading directions, includes: a flowmeter main body; a casing arranged at an outer side of the flowmeter main body; and a digital display device. The digital display device is electrically connected with the flowmeter main body so as to read the numerical value of the flowmeter main body, and the digital display device is rotatably connected on the casing to adjust the display direction of the numerical value in the digital display device.

In a preferred embodiment, the casing includes a cavity, and an annular protrusion arranged in the cavity, the annular protrusion divides the cavity into an upper cavity and a lower cavity, and the digital display device includes: an adjusting member rotatably disposed in the upper cavity; a limiting ring and a digital display assembly. The limiting ring is positioned in the lower cavity and is fixedly connected with the lower end of the adjusting member, the limiting ring and the adjusting member are arranged in parallel and spaced with each other, such that the annular projection can be clamped between the adjusting member and the limiting ring. The digital display assembly is mounted on the adjusting member.

In a preferred embodiment, a damping structure is arranged between the limiting ring and the annular protrusion, such that the adjusting member can have a damping adjustment relative to the casing.

In a preferred embodiment, at least one of the limiting ring and the annular protrusion is made of an elastic material, and the damping structure includes: a plurality of limiting protrusions each arranged on the limiting ring; and a plurality of limiting grooves provided at the lower end of the annular protrusion and configured for cooperating with the limiting protrusions.

In a preferred embodiment, the digital display device further includes: a conductive plate mounted at the lower end of the intermediate connection plate, the bottom of the conductive plate being provided with an anode conductive ring and a cathode conductive ring which are coaxially arranged; a battery mounted in the lower cavity of the casing; a first conductive plate, one end of the first conductive plate being connected to the anode of the battery, and the other end of the first conductive plate being in contact with the anode conductive ring; and a second conductive plate, one end of the second conductive plate being connected to the cathode of the battery, and the other end of the second conductive plate being in contact with the cathode conductive ring.

In a preferred embodiment, the first conductive plate and the second conductive plate are made of an elastic material, such that the first conductive plate can be in constant contact with the anode conductive ring, and the second conductive plate can be in constant contact with the cathode conductive ring.

In a preferred embodiment, the first conductive plate is Y-shaped, so that the first conductive plate has two abutting points with the anode conductive ring, and the second conductive plate is Y-shaped, so that the second conductive plate has two abutting points with the cathode conductive ring.

### (3) Beneficial Effects

Compared with the prior art, the present invention brings the following beneficial effects:

The flowmeter with adjustable reading directions, includes a flowmeter main body, a casing and a digital display device, wherein the casing is arranged at the outer side of the flowmeter main body; the digital display device is electrically connected with the flowmeter main body so as to read the numerical value of the flowmeter main body; the digital display device is rotatably connected on the casing to adjust the display direction of the numerical value in the digital display device. In actual use process, the casing can support and fix other parts, and the digital display device is rotatably connected to the casing, so that the digital display device is equivalent to being indirectly arranged on the flowmeter main body, further because the digital display device is electrically connected with the flowmeter main body, the numerical value of the flowmeter main body can be read by the digital display device, and by rotating the digital display device, the value can be directly aligned with and face to the working personnel, therefore it is convenient for the working personnel to read and record the numerical value. Concluded from the above, the reading direction of the digital display device can be adjusted by using the flowmeter which is convenient for reading values.

### BRIEF DESCRIPTION OF THE DRAWINGS

The accompanying drawings are used to provide a further understanding of the present invention, and constitute a part of the description, and are used to explain the present invention together with the embodiments of the present invention, and do not constitute a limitation to the present invention. In the attached drawings:

FIG. 1 is a schematic structural view of the flowmeter according to an embodiment of the present invention.

FIG. 2 is another schematic structural view of the flowmeter according to the embodiment of the present invention.

FIG. 3 is a schematic cross sectional view of the flowmeter according to the embodiment of the present invention.

FIG. 4 is a schematic exploded view of the flowmeter according to the embodiment of the present invention.

FIG. 5 is another schematic exploded view of the flowmeter according to the embodiment of the present invention.

FIG. 6 is a schematic structural view of an upper casing according to the embodiment of the present invention.

FIG. 7 is another schematic structural view of an upper casing according to the embodiment of the present invention.

FIG. 8 is a schematic structural view of a lower casing according to the embodiment of the present invention.

FIG. 9 is a schematic structural view of an adjusting member according to the embodiment of the present invention.

FIG. 10 is a schematic structural view of a limiting ring according to the embodiment of the present invention.

FIG. 11 is a schematic structural view of a conductive plate according to the embodiment of the present invention.

FIG. 12 is another schematic structural view of a conductive plate according to the embodiment of the present invention.

FIG. 13 is a partial schematic structural view of the flowmeter according to the embodiment of the present invention.

FIG. 14 is another partial schematic structural view of the flowmeter according to the embodiment of the present invention.

FIG. 15 is a schematic structural view of a first conductive plate according to the embodiment of the present invention.

FIG. 16 is a schematic structural view of a second conductive plate according to the embodiment of the present invention.

Labels in the drawings: 1, flowmeter main body; 2, casing; 201, upper casing; 202, lower casing; 21, upper cavity; 22, lower cavity; 3, digital display device; 31, adjusting member; 32, limiting ring; 321, arc-shaped groove; 33, digital display assembly; 34, intermediate connecting plate; 35, digital display panel; 36, control device; 361, central control board; 362, magnetic force sensor; 363, key; 37, conductive plate; 371, anode conductive ring; 372, cathode conductive ring; 38, battery; 381, battery cover; 391, first conductive plate; 392, second conductive plate; 4, annular protrusion; 5, damping structure; 51, limiting protrusion; 52, limiting groove.

### DETAILED DESCRIPTION OF PREFERRED EMBODIMENTS

The following description will refer to the accompanying drawings to more fully describe the contents of the present application. It is apparent that here only constitutes a part of the embodiments of the present invention, not all of the embodiments. Based on the embodiments of the present invention, all other embodiments obtained by persons of ordinary skill in the art without making creative efforts belong to the protection scope of the present invention.

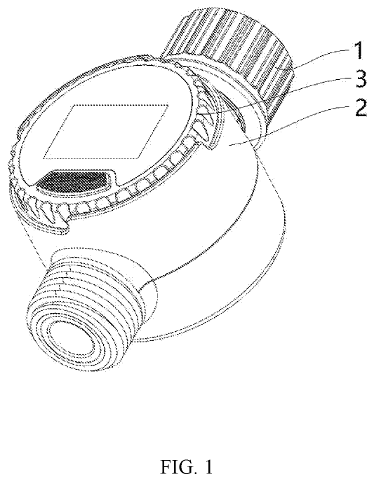

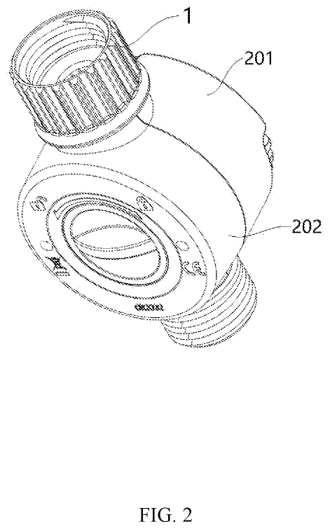

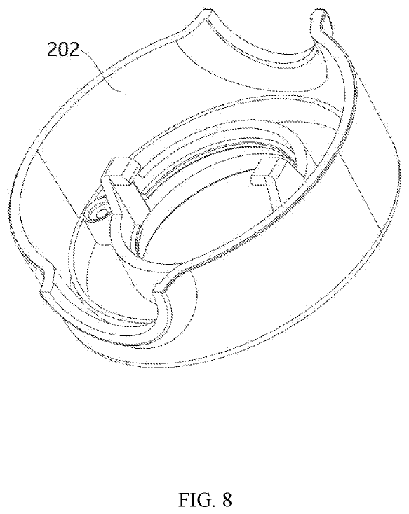

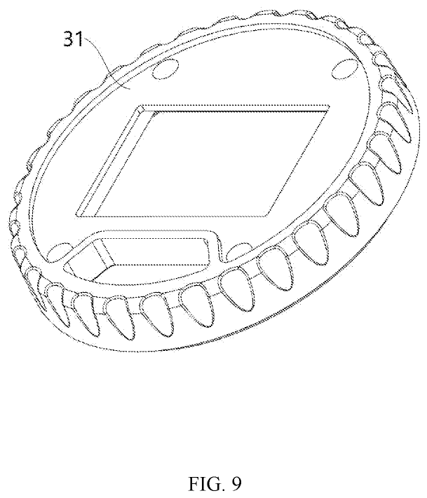

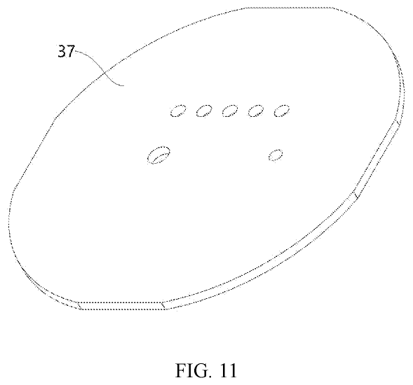

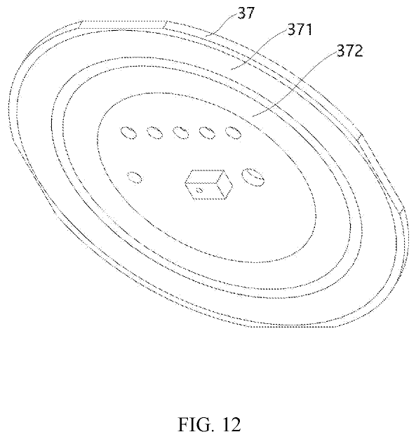

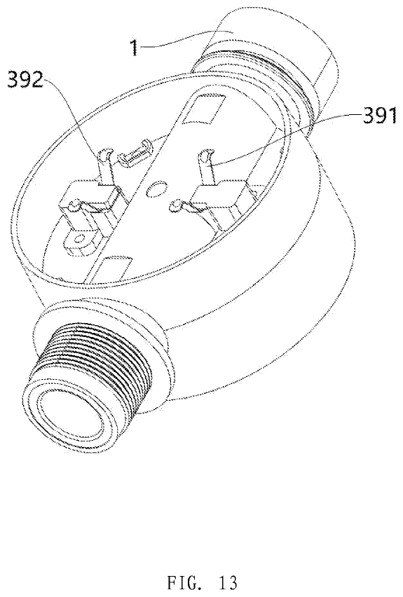

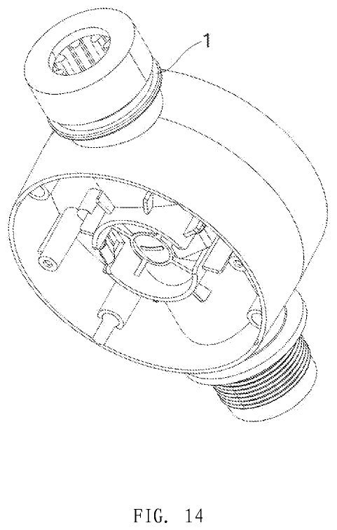

Referring to FIG. 1 to FIG. 16, the embodiment of the present invention discloses a flowmeter with adjustable reading directions, which includes a flowmeter main body 1, a casing 2 and a digital display device 3, wherein the casing 2 is arranged at the outer side of the flowmeter main body 1. The digital display device 3 is electrically connected with the flowmeter main body 1 to read the numerical value of the flowmeter main body 1, and the digital display device 3 is rotatably connected to the casing 2 to adjust the display direction of the numerical value in the digital display device 3.

In the actual use process, the casing 2 can be non-detachably connected to the flowmeter main body 1 or detachably connected to the flowmeter main body 1. In this embodiment, the casing 2 is detachably connected to the flowmeter main body 1 in order to be more convenient to install and easy to replace after the casing 2 is damaged. In addition, the digital display device 3 is rotatably connected to the casing 2, therefore, after the flowmeter main body 1 and the casing 2 are installed, the numerical value of the flowmeter main body 1 can be read by the digital display device 3, and the numerical value of the digital display device 3 can be aligned with and face to a working personnel by rotating the digital display device 3, which is convenient for working personnel to read and record the numerical value. In general, the reading direction of the digital display device 3 can be adjusted by using the flowmeter which is convenient for reading the numerical value.

Referring to FIG. 1 to FIG. 5, furthermore, the casing 2 includes an upper casing 201 and a lower casing 202, the upper casing 201 and the lower casing 202 are connected together by a threaded connection, and the connecting portion of the upper casing 201 and the lower casing 202 is provided with a mounting space corresponding to the flowmeter main body 1, so that the upper casing 201 and the lower casing 202 can be installed and fixed on the flowmeter main body 1.

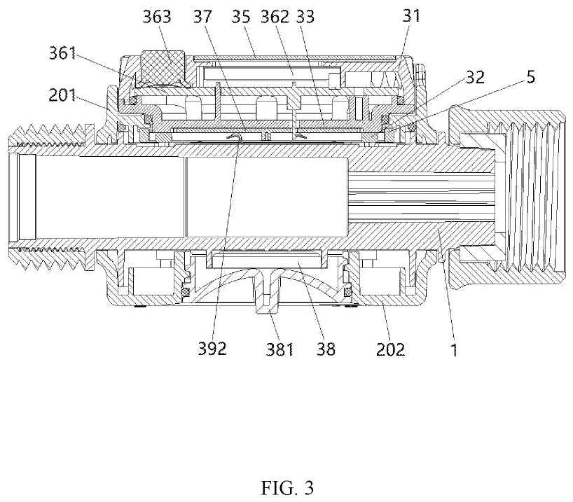

Referring to FIG. 3 to FIG. 7, in order to realize the rotational connection between the digital display device 3 and the casing 2, the structure of the digital display device 3 is designed as follows. Specifically, the casing 2 includes a cavity, wherein an annular protrusion 4 is arranged in the cavity, the annular protrusion 4 divides the cavity into an upper cavity 21 and a lower cavity 22. The digital display device 3 includes an adjusting member 31, a limiting ring 32 and a digital display assembly 33, the adjusting member 31 is rotatably disposed in the upper cavity 21. The limiting ring 32 is positioned in the lower cavity 22 and is fixedly connected with the lower end of the adjusting member 31, and the limiting ring 32 and the adjusting member 31 are arranged in parallel with each other and have a distance spaced from each other, so that the annular projection 4 can be clamped between the adjusting member 31 and the limiting ring 32. The digital display assembly 33 is mounted on the adjusting member 31, by rotating the adjusting member 31, the limiting ring 32 and the digital display assembly 33 can rotate accordingly, thereby adjusting the display direction of the numerical value in the digital display assembly 33.

Through the design of the above structure, the adjusting member 31 and the limiting ring 32 can not only be rotatably connected in the casing 2, but also can prevent the two components from falling off the casing 2. When the casing 2 is composed of the upper casing 201 and the lower casing 202 and the adjusting member 31 and the limiting ring 32 are detachably connected, it is also possible to replace the damaged adjusting element 31 or the limiting ring 32.

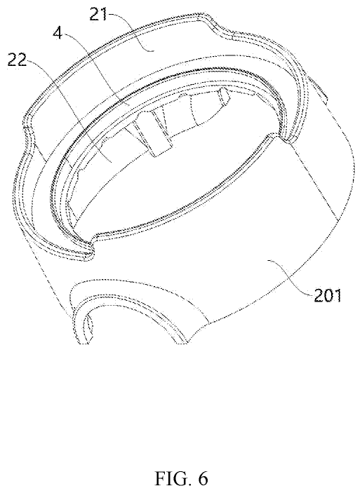

Referring to FIG. 1 and FIG. 6, further, a notch may be provided at the upper side of the casing 2, and the adjusting member 31 is only exposed at the notch and the exposed part is provided with anti-slip lines to facilitate rotation and reduce the volume of the whole device. It is also possible to extend the end of the adjusting member 31 completely out of the casing 2 for easy rotation and the structure is simple, which is prior art and therefore not shown in the drawings.

Referring to FIG. 3, the digital display device 3 is rotatably connected to the casing 2, although the numerical value display direction can be adjusted, when the digital display device 3 is used, the rotation of the adjusting member 31 is too sensitive, and the numerical value display direction can be changed due to slight vibration, which is unfavorable for reading and recording for working personnels. In order to avoid this, in this embodiment, in particular, a damping structure 5 is arranged between the limiting ring 32 and the annular protrusion 4, so that the adjusting member 31 has damping adjustment relative to the casing 2, such that the adjusting member 31 does not rotate by itself without the influence of an external force, thereby facilitating the unfolding work of a working personnel.

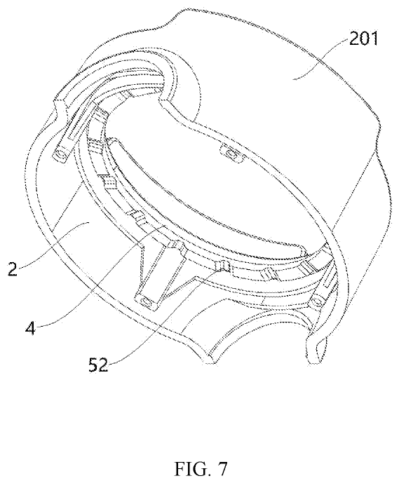

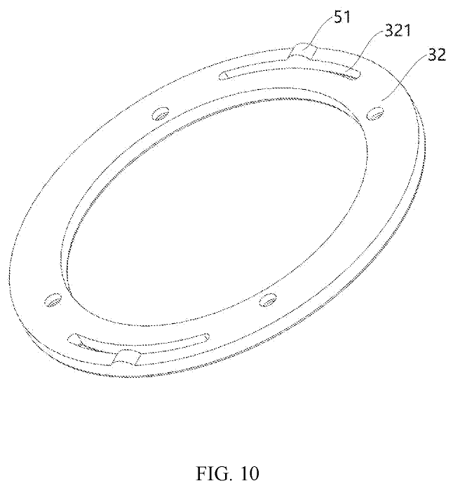

Referring to FIG. 7 and FIG. 10, the damping structures 5 capable of realizing the above functions are various, and a specific structure is provided in this embodiment. Specifically, at least one of the limiting ring 32 and the annular protrusion 4 is made of an elastic material. The damping structure 5 includes a plurality of limiting protrusions 51 and a plurality of limiting grooves 52, and the plurality of limiting protrusions 51 are all arranged on the limiting ring 32. The limiting grooves 52 are provided at the lower end of the annular protrusion 4 and cooperate with the limiting protrusions 51.

According to the above scheme, the limiting protrusion 51 in a natural state is positioned in the limiting groove 52, and then the adjusting member 31 is rotated when the numerical direction is adjusted, and the limiting ring 32 rotates along with the adjusting member 31. Because at least one of the limiting ring 32 and the annular protrusion 4 is made of an elastic material, at least one of the limiting ring 32 and the annular protrusion 4 is elastically deformed, such that the limiting protrusion 51 on the limiting ring 32 can be disengaged from the limiting groove 52 on the annular protrusion 4, and damps the rotating of the adjusting member 31. Finally, the limiting protrusion 51 is moved to the designated limiting groove 52, the adjustment of the numerical direction can be completed. In addition, the limiting groove 52 may be equally spaced in an annular array to facilitate determination of the adjustment angle.

Referring to FIG. 10, furthermore, the limiting ring 32 in this embodiment is made of an elastic material. The limiting ring 32 is provided with an arc-shaped groove 321 corresponding to the limiting protrusion 51. The arc-shaped groove 321 is arranged between the limiting protrusion 51 and the center of the limiting ring 32.

By arranging the arc-shaped groove 321, when the adjusting member 31 rotates, the position of the limiting ring 32 corresponding to the limiting protrusion 51 is easier to deform and the deformed part is larger. When the limiting protrusion 51 moves to the next limiting groove 52, the deformed part is reset due to the elasticity of the limiting protrusion 51 and collides with the annular protrusion 4, with “click” or the like sound, thereby alerting the working personnel that the adjustment member 31 has been adjusted to a certain angle.

Referring to FIG. 3 to FIG. 5, in order to enable the digital display device 3 to be installed at a specified position on the casing 2 and to measure the parameters of the flowmeter main body 1, the digital display assembly 33 is designed as follows. Specifically, the digital display assembly 33 includes an intermediate connecting plate 34, a digital display panel 35 and a control device 36. The intermediate connecting plate 34 is connected between the adjusting member 31 and the limiting ring 32, and a mounting cavity is formed between the intermediate connecting plate 34 and the adjusting member 31. The digital display panel 35 is mounted on the upper end surface of the adjusting member 31; the control device 36 is installed in the mounting cavity and electrically connected with the digital display panel 35. The bottom of the intermediate connecting plate 34 is connected with the limiting ring 32, the top of the intermediate connecting plate 34 is connected with the adjusting member 31, and the side surface of the intermediate connecting plate 34 is connected with the annular protrusion 4 in a sliding manner, so that each component is more convenient to install, the structure is more compact and firm, and the control device 36 can measure, collect and process the parameters of the flowmeter main body 1 and finally display the parameters on the digital display panel 35.

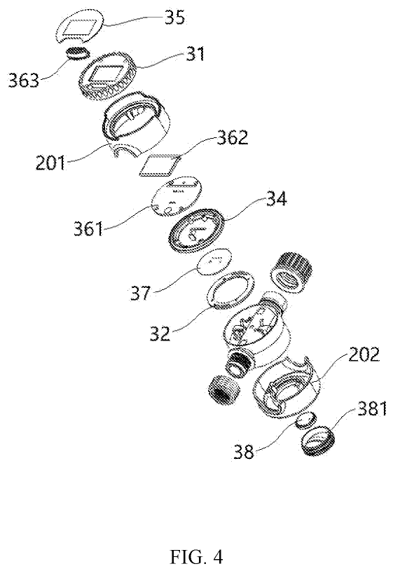

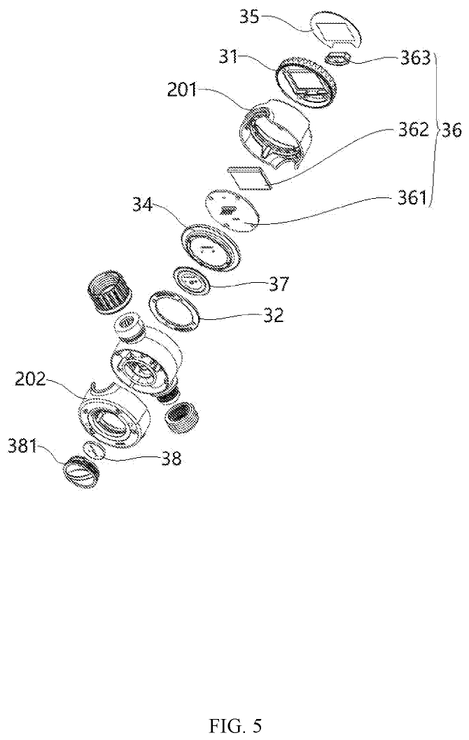

Referring to FIG. 4 and FIG. 5, in order to make the control device 36 work normally, the structure of the control device 36 is designed as follows. Specifically, the flow meter in the flow meter main body 1 is a turbine flow meter and the blades in the turbine flow meter are made of magnetic materials. The control device 36 includes a central control board 361, a magnetic force sensor 362 and a key 363, the magnetic sensor 362 is located below the adjustment member 31, magnetic signals generated when the blades rotate can be converted into electrical signals, the central control plate 361 is positioned between the magnetic force sensor 362 and the limiting ring 32, the central control board 361 is also provided with a button 363 with one end exposed out of the adjusting member 31, for switching the working mode of the digital display device 3, the digital display panel 35, a magnetic sensor 362, keys 363, the flowmeter main body 1 is electrically connected with the central control board 361, such that the central control board 361 can control each electrical component.

Referring to FIGS. 3-5 and FIG. 13, in order to make the digital display device 3 work normally, it is necessary to provide an energy supply component. In order to enable the digital display device 3 to be powered by the energy supply component continuously during the rotation process, the following design is made in this embodiment. Specifically, the digital display device 3 further includes a conductive plate 37, a battery 38, a first conductive plate 391, a second conductive plate 392. The conductive plate 37 is mounted at the lower end of the intermediate connection plate 34, the bottom of the conductive plate 37 is provided with an anode conductive ring 371 and a cathode conductive ring 372 which are coaxially arranged. The battery 38 is mounted in the lower cavity 22 of the casing 2. One end of the first conductive plate 391 is connected to the anode of the battery 38, and the other end is in contact with the anode conductive ring 371. One end of the second conductive plate 392 is connected to the cathode of the battery 38, and the other end of the second conductive plate 392 is in contact with the cathode conductive ring 372. In an actual use process, a battery cover 381 corresponding to the battery 38 is provided on the casing 2 so as to facilitate disassembly and assembly of the battery 38.

Through the above arrangement, the electric components in the digital display device 3 can be energized through the battery 38, and the conductive plate 37, the battery 38, the first conductive plate 391 and the second conductive plate 392 can form a closed energizing circuit. During the rotation of the regulating member 31, the first conductive plate 391 is connected with the anode conductive ring 371, the second conductive plate 392 and the cathode conductive ring 372 are connected in a contact conductive manner, so that the digital display device 3 can still maintain the closed state of the whole circuit in the rotating process, can still be continuously powered by the battery 38.

In the above embodiment, the specific materials of the first conductive plate 391 and the second conductive plate 392 are not limited. If the first conductive plate 391 and the second conductive plate 392 are made of rigid materials, the contact conduction effect can also be achieved, but abrasion will inevitably occur after long-term use, resulting in no contact between the first conductive plate 391 and the anode conductive ring 371 or between the second conductive plate 392 and the cathode conductive ring 372, so that a disconnection phenomenon is generated. In order to avoid this, in this embodiment, the first conductive plate 391 and the second conductive plate 392 are made of an elastic material, such that it can be ensured that the first conductive plate 391 is in constant contact with the anode conductive ring 371, the second conductive plate 392 is in constant contact with the cathode conductive ring 372, even if abrasion occurs at the contact portion, the circuit breaking phenomenon cannot be generated, the energy supply is more stable. In practical use, both the first conductive plate 391 and the second conductive plate 392 may be spring pieces.

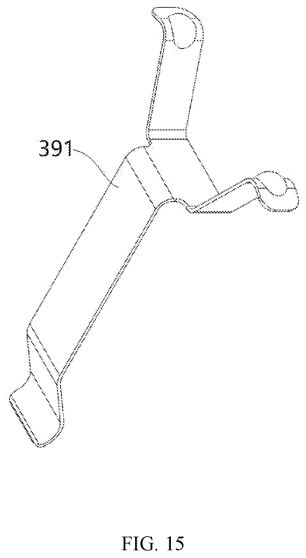

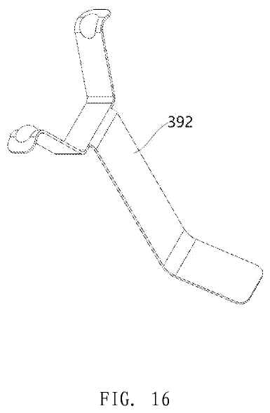

Referring to FIG. 15 and FIG. 16, furthermore, in this embodiment, the structures of the first conductive plate 391 and the second conductive plate 392 are designed as follows, specifically, the first conductive plate 391 is Y-shaped, so that the first conductive plate 391 has two abutting points with the anode conductive ring 371, and the second conductive plate 392 is Y-shaped, so that the second conductive plate 392 has two abutting points with the cathode conductive ring 372.

Through the design of the structure, the following beneficial effects can be brought:
Firstly, the two abutting points can evenly share the pressure of the anode conductive ring 371 applied on the first conductive plate 391 or the cathode conductive ring 372 applied on the second conductive plate 392 on the two abutting points, so as to prevent the abutting parts from being worn too quickly. It should be noted that the contact points can be not only two, but also multiple, and can be set according to actual needs;
Secondly, when the adjusting member 31 rotates, the traction force received by the abutting part is larger and is more likely to be damaged. According to the embodiment, the two abutting points are arranged, so that the force applied in the rotation can be shared equally and is not easy to damage.

Thirdly, since the anode conductive ring 371 is in elastic contact with the first conductive plate 391 and the second conductive plate 392, results that the first conductive plate 391 and the second conductive plate 392 are necessarily inclined to one side. For example, the inclined directions of the first conductive plate 391 and the second conductive plate 392 are consistent with the directions when the adjusting member 31 rotates clockwise, such that when the adjusting member 31 is rotated clockwise, the inclined direction of the first conductive plate 391 and the second conductive plate 392 coincide with the direction in which the deformation occurs, results that the resistance to which the adjusting member 31 is subjected is small; while rotating the adjusting member 31 counterclockwise, the inclined direction of the first conductive plate 391 and the second conductive plate 392 is opposite to the direction in which the deformation occurs, such that the resistance to which the adjusting member 31 is subjected is large, this leads to a working personnel rotating the adjusting member 31 clockwise and counterclockwise with different forces, the hand feeling is inconsistent, inconvenient to use. In this embodiment, the first conductive plate 391 and the second conductive plate 392 are both Y-shaped, when the adjusting member 31 is rotated clockwise or counterclockwise, one inclined branch of the first conductive plate 391 and the second conductive plate 392 is relatively stressed, and the other inclined branch is stressed more, but the sum of the two forces added together is constant, this allows the adjusting member 31 to rotate clockwise or counterclockwise, the force required is the same.

It is noted that the terminology used herein is for the purpose of describing particular embodiments only and is not intended to limit the exemplary embodiments according to the present application. As used herein, singular forms are intended to include plural forms unless the context clearly dictates otherwise, and it should also be understood that when the terms of “include” are used in this specification, they specify the presence of features, steps, operations, devices, components, and/or combinations thereof.

In addition, it should be noted that the words “first” and “second” are used to define the parts only for the convenience of distinguishing the corresponding parts. Unless otherwise stated, the above words have no special meaning, so they cannot be construed as limiting the scope of protection of the present application.

While embodiments of the present invention have been shown and described, it will be understood by those skilled in the art that various changes, modifications, substitutions and variations may be made to these embodiments without departing from the principles and spirit of the invention, the scope of which is defined by the appended claims and their equivalents.

What is claimed is:

1. A flowmeter, comprising:
a flowmeter main body;
a casing arranged at an outer side of the flowmeter main body; and
a digital display device, the digital display device being electrically connected with the flowmeter main body so as to obtain the numerical value of the flowmeter main body, and the digital display device being rotatably connected on the casing to adjust the display direction of the numerical value in the digital display device to allow the flowmeter to have adjustable reading directions.

2. The flowmeter according to claim 1, wherein the casing comprises a cavity, and an annular protrusion arranged in the cavity, the annular protrusion divides the cavity into an upper cavity and a lower cavity, and the digital display device comprises:
an adjusting member rotatably disposed in the upper cavity;
a limiting ring positioned in the lower cavity and fixedly connected with the lower end of the adjusting member, the limiting ring and the adjusting member being arranged in parallel and spaced with each other, such that the annular projection can be clamped between the adjusting member and the limiting ring; and
a digital display assembly mounted on the adjusting member.

3. The flowmeter according to claim 2, wherein a damping structure is arranged between the limiting ring and the annular protrusion, such that the adjusting member can have a damping adjustment relative to the casing.

4. The flowmeter according to claim 3, wherein at least one of the limiting ring and the annular protrusion is made of an elastic material, and the damping structure comprises:
a plurality of limiting protrusions each arranged on the limiting ring; and
a plurality of limiting grooves provided at a lower end of the annular protrusion and configured for cooperating with the limiting protrusions.

5. The flowmeter according to claim 4, wherein the limiting ring is made of an elastic material, and the limiting ring is provided with arc-shaped grooves corresponding to the limiting protrusions, and the arc-shaped grooves are arranged between the limiting protrusion and a center of the limiting ring.

6. The flowmeter according to claim 2, wherein the digital display assembly comprises:
an intermediate connecting plate connected between the adjusting member and the limiting ring, and a mounting cavity being formed between the intermediate connecting plate and the adjusting member;
a digital display panel mounted on an upper end surface of the adjusting member; and
a control device being installed in the mounting cavity and electrically connected with the digital display panel.

7. The flowmeter according to claim 6, wherein the digital display device further comprises:
a conductive plate mounted at a lower end of the intermediate connection plate, the bottom of the conductive plate being provided with an anode conductive ring and a cathode conductive ring which are coaxially arranged;
a battery mounted in the lower cavity of the casing;
a first conductive plate, one end of the first conductive plate being connected to the anode of the battery, and the other end of the first conductive plate being in contact with the anode conductive ring; and
a second conductive plate, one end of the second conductive plate being connected to the cathode of the battery, and the other end of the second conductive plate being in contact with the cathode conductive ring.

8. The flowmeter according to claim 7, wherein the first conductive plate and the second conductive plate are made of an elastic material, such that the first conductive plate can be in constant contact with the anode conductive ring, and the second conductive plate can be in constant contact with the cathode conductive ring.

9. The flowmeter according to claim 7, wherein the first conductive plate is Y-shaped, so that the first conductive plate has two abutting points with the anode conductive ring, and the second conductive plate is Y-shaped, so that the second conductive plate has two abutting points with the cathode conductive ring.
